(19) United States
(12) Patent Application Publication
(10) Pub. No.: US 2022/0351171 A1
(43) Pub. Date: Nov. 3, 2022

(54) BULK PURCHASE SOFTWARE APPLICATION

(71) Applicant: Nadia Grogan, Ottawa (CA)

(72) Inventor: Nadia Grogan, Ottawa (CA)

(21) Appl. No.: 17/243,535

(22) Filed: Apr. 28, 2021

(51) Int. Cl. G06Q 20/20; G06F 8/60; G06Q 30/06; G06Q 20/12; G06Q 10/08; G06K 19/06; G06F 16/9535; G01G 19/414

(52) U.S. Cl. CPC G06Q 20/208; G06F 8/60; G06Q 30/0633; G06Q 20/12; G06Q 10/0875; G06K 19/06028; G06K 19/06037; G06F 16/9535; G01G 19/4144; G06Q 20/3276

(57) ABSTRACT

A software application that facilitates a method for a user to purchase bulk items from a retailer. The present invention incorporates the use of containers provided by the retailer or the user wherein the containers are assigned a container identifier having as a part thereof the weight of the container. The retailer provides a product identifier for all of the products available for sale. A preferred embodiment of the latter are QR codes or barcodes. The user will identify the product for purchase and scan the product identifier. The product is dispensed into the container after weighing thereof. A plurality of scales are provided to weigh the products wherein the scales are communicably coupled to the smart phone of the user so as to transmit the weight of the products thereto. A shopping list database is created at each shopping excursion that contains all of the products selected for purchase.

### FIELD OF THE INVENTION

The present invention relates generally to retail purchase software applications, more specifically but not by way of limitation, a software application that is configured to facilitate a purchase transaction of bulk items such as but not limited to bulk food items.

### BACKGROUND

Consumers purchase items such as but not limited to food in a variety of different types of packaging. The packaging material can include materials such as but not limited to plastic and cardboard. While some of the packaging is recycled, a good portion becomes undesirable waste. Some retailers provide various types of food and other items in bulk wherein a customer can purchase a portion of the bulk items. This eliminates the need for manufactured individual consumer packaging which leads to reduced waste. Another benefit of bulk items is the lower cost to the consumer. While the availability of bulk items has been available for years there are some inconvenient aspects that have kept this type of retail from expanding and reaching its potential as a more environmentally sustainable alternative to the presentation of goods at traditional stores.

Existing bulk item purchase transactions can be cumbersome due to some of the requirements from the retailer. It is common for retailers to require the customer to document the bin number from which they retrieved the item. Additionally, the customer may be required to input the bin or product number into a kiosk during the checkout procedure which requires additional retention of the numbers for the associated items that results in a burden to the consumer. Lastly, if a customer is utilizing a container of their own, personnel at the store will have to weigh the container prior to the customer filling with the bulk items. This process typically results in a delay in the shopping process which is inconvenient to many.

It is intended within the scope of the present invention to provide a software application that facilitates the purchase of bulk items wherein the present invention integrates container use, checkout procedures and other tasks intrinsic to the purchase of bulk items so as to provide automation thereof such as tare weight recall of reusable containers.

### SUMMARY OF THE INVENTION

It is the object of the present invention to provide a software application that is configured to facilitate the purchase of bulk items such as but not limited to food, wherein the software of the present invention is operated on a mobile computing device such as but not limited to a smart phone.

Another object of the present invention is to provide a software application operable to expedite the purchase of bulk items wherein the software application includes the capture of a photographic image of a bar code or QR code that is present on the label identifying the product by name or on the bin having the bulk item stored therein.

A further object of the present invention is to provide a software application that is configured to facilitate the purchase of bulk items such as but not limited to food, wherein the present invention includes generation of a barcode or QR code that contains the information of all of the bulk items purchased.

Still another object of the present invention is to provide a software application operable to expedite the purchase of bulk items wherein the present invention further includes the providing of integrated scales within the retail location.

An additional object of the present invention is to provide a software application that is configured to facilitate the purchase of bulk items such as but not limited to food, wherein the scales are utilized to weigh a container being used to place the bulk items in and the weight thereof is stored for subsequent use by the software application.

Yet a further object of the present invention is to provide a software application operable to expedite the purchase of bulk items wherein the software application wherein the present invention provides the ability to re-use a container previously utilized as records thereof are maintained.

Another object of the present invention is to provide a software application that is configured to facilitate the purchase of bulk items such as but not limited to food, wherein the re-usable container being utilized to place bulk items therein is provided with an identifier such as but not limited to a barcode or QR code.

An alternate object of the present invention is to provide a software application operable to expedite the purchase of bulk items wherein the software application wherein the software application has incorporated therein a product inventory database.

Still a further object of the present invention is to provide a software application that is configured to facilitate the purchase of bulk items such as but not limited to food, wherein the software application is operably integrated to provide tracking of programs such as but not limited to loyalty programs.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a process chart of the present invention utilizing reusable containers not purchased in a store; and

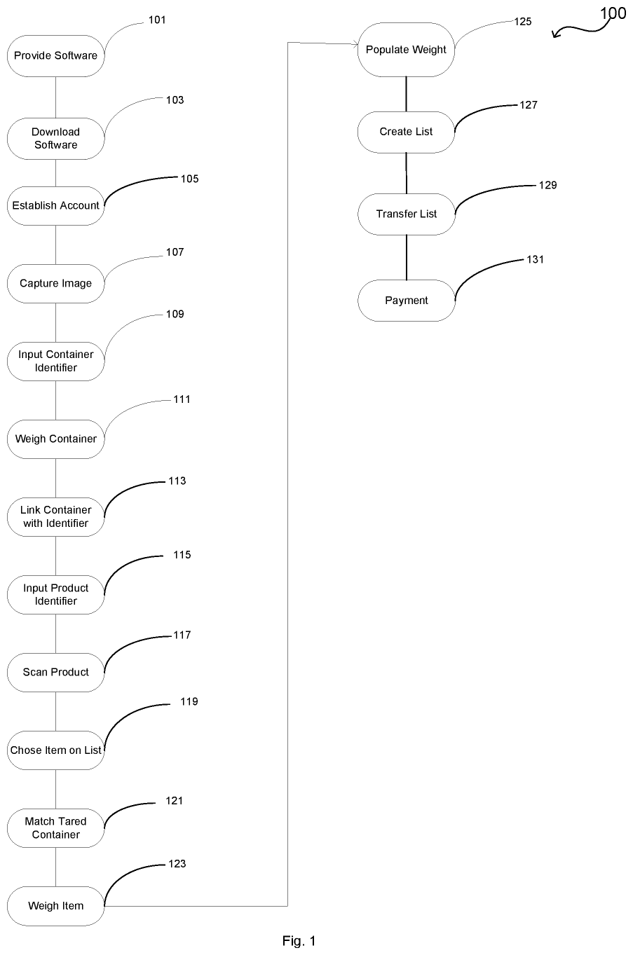

FIG. 2 is a process chart of the present invention utilizing a container provided by a store wherein the container is available for purchase or through loan.

### DETAILED DESCRIPTION

References now to the drawings submitted herewith, wherein various elements depicted therein are not necessarily drawn to scale and wherein through the views and figures like elements are referenced with identical reference numerals, there is illustrated a bulk item purchasing software application 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring now to the drawings submitted herewith, the bulk item purchasing software application 100 is executed on a mobile computing device such as but not limited to a smart phone. The bulk item purchasing software application 100 is embodied as a software application downloaded to the mobile computing device from a suitable location such as but not limited to a computer server accessible via conventional communication protocols. In step 101, the provider of the bulk item purchasing software application 100 publishes the software application of the present invention to an accessible computing location. Step 103, the user will access the computing location and download the software application to their mobile computing device. In step 105, the user will activate the software application of the present invention and create an account. It should be understood within the scope of the present invention that the account contains data parameters such as but not limited to username, personal data and payment data. In step 107, as a user begins to use the bulk item purchasing software application 100 to commence purchasing bulk items, the user will capture a photographic image of the container in which they will be placing the bulk items. The container can be an item such as but not limited to a lidded glass jar wherein user will repeat use thereof during subsequent shopping excursions. The captured image is stored on the smart phone by the software application of the present invention.

In step 109, the user will input a container identifier that is stored so as to be utilized in association with the container when the container is utilized during a shopping excursion. It is contemplated within the scope of the present invention that the container identifier can be a QR code or a barcode. It should further be understood within the scope of the present invention that more than one container can be recorded and stored for use during shopping excursions. In step 111, the weight of the container is captured and stored as part of the records thereof. Capturing of the weight of the container provides the ability for accurate weight to be taken of the bulk items placed therein so as to not include the weight of the container. In step 113, the container and its information thereabout including the weight and photographic image is associated with its unique container identifier. It should be understood within the scope of the present invention that the container identifier can be updated if needed.

In step 115, the user will input a product identifier. The product identifier is a unique identifier that is provided for each bulk item for which a user will purchase a portion thereof and place in the container. It should be understood within the scope of the present invention that the product identifier can be a QR code, barcode or other suitable type of identifier. It should be understood within the scope of the present invention that a plurality of product identifier's will be inputted into the software application of the present invention and stored therein. It is contemplated within the scope of the present invention that the product identifiers can be input by the user or the retailer can provide a database list wherein this database list of product identifiers is downloaded to the software application of the present invention. Furthermore, the database list can be periodically updated by the retailer and provided to the user of the bulk item purchasing software application 100.

In step 117, a user will input product identifier by scanning or other suitable technique at the scale of the present invention. The bulk item purchasing software application 100 includes weight scales that are placed in various locations within the bulk retailer store. The scales are communicably coupled to the smart phone having the software application of the present invention. The scales are utilized to measure the amount of bulk item placed in the container for purchase thereof. It should be understood within the scope of the present invention that as few as one scale could be present or a plurality of scales installed at a bulk retailer location or be incorporated into a self-checkout kiosk. In step 119, the user will select a product identifier of the product they intend to purchase. Step 121, the user will identify which container that the product will be placed after weighing thereof. In step 123, the user will weigh the product and subsequently placed in the identified container. It should be further understood within the scope of the present invention that the steps 121 and 123 could be reversed wherein the product could be placed in the container first. The scale will transmit the recorded weight to the software application of the present invention wherein a shopping list database is created. The shopping list database will keep a record of all of the product identifiers and the weights thereof that are weighed and placed in a container for purchase. The shopping list database is created and stored during a shopping excursion as a technique to facilitate transfer of the information to the bulk retailer in a consolidated manner. It should be further understood within the scope of the present invention that a record of all of the product identifiers could be maintained and transmitted utilizing alternate suitable techniques.

In step 125, the weight of all of the products weighed utilizing the scale of the present invention are populated into the shopping list database as each product is weighed and subsequently placed in a container. Step 127, the shopping list database is finalized ensuing all of the desired products being weighed and placed into the containers wherein the shopping list database includes records of all of the product identifiers, weight of each product and the identity of the container in which the product was placed. In step 129, the user of the bulk item purchasing software application 100 will transfer the shopping list database to an individual or to a self-checkout kiosk in the bulk retailer. During this process, it is contemplated during the scope of the present invention that the entire container having the products disposed therein could be weighed wherein the weight of the filled container is cross-referenced with the total weight of the products listed in the shopping list database. In step 131, the user of the bulk item purchasing software application 100 will execute a financial transaction with the retailer in order to pay for all of the products the user dispensed.

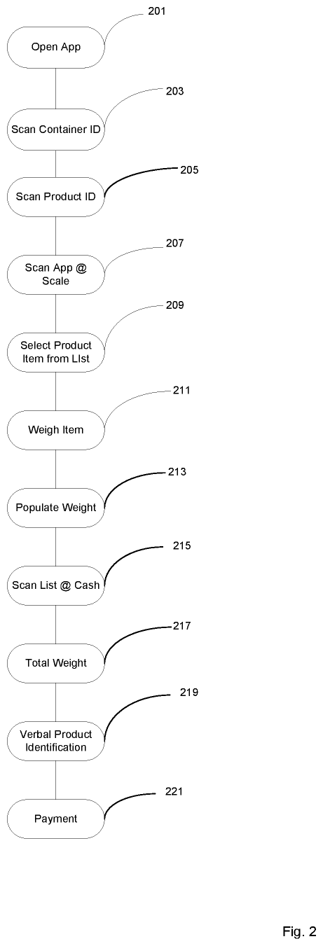

Referring to FIG. 2 submitted herewith, an exemplary process is diagrammed wherein the user will utilize a container provided by the bulk retailer. It should be understood within the scope of the present invention that the retailer could provide containers to users of the bulk item purchasing software application 100 either for a fee, wherein fee is to be understood as a purchase or a loan with deposit, or free of charge. In step 201, the user will activate the software application of the bulk item purchasing software application 100. Step 203, the user will scan the container provided to them by the store wherein the container has associated therewith a container identifier. It should be further understood within the scope of the present invention that the present invention could utilize bags that do not require weighing prior to filling. As previously discussed herein, the container identifier can be a QR code, barcode or similar equivalent thereof. The container identifier has associated therewith the necessary information about the container such as but not limited to the weight. Once the container is scanned to a user, the container information about the weight thereof will be populated into the software application and as such this weight will be accounted for during the checkout process.

In step 205, the user will begin the shopping excursion by scanning the product identifiers for the products desired to be purchased. The product identifiers are loaded into a shopping list database wherein the unit cost information thereof is populated thereinto. The user will place all of the desired products into one or more than one container. Step 207, the user will activate communication with a scale located in the bulk retailer facility. In step 209, the user will select one of the product identifiers from the shopping list database and transmit to the scale that this product is about to be weighed. In step 211, the product is weighed on the scale and ensuing the weighing of the product the total cost is calculated and stored in the shopping list database in step 213. In step 215, the shopping list database is presented to an individual at the bulk retailer in order to initiate the execution of a financial transaction for the products placed in the container and present in the shopping list database. Step 217, the individual may weigh the entire container having the products therein and perform a cross-reference of the observed weight and the total weight listed in the shopping list database. In step 219, a verbal confirmation of the products may be provider by the user during the checkout process. Step 221, the user of the bulk item purchasing software application 100 will pay for the products placed in the container wherein this transaction can automatically be executed by the software application with payment method information that is incorporated into the account profile information for the user or via traditional means such as a cashier or self-checkout kiosk.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the claims.

What is claimed is:

1. A method operable to facilitate purchase of at least one bulk item from a retailer wherein the method comprises the steps of:
providing a software application, said software application configured to execute the method, said software application located on a computer server communicably coupled to Internet;
downloading the software application, wherein at least one user and at least one retailer download the software application onto a suitable computing device;
creating an account profile, wherein the at least one user will create the account profile within the software application;
providing at least one scale, wherein the at least one scale is placed within a facility of the retailer, said at least one scale operable to weigh items placed thereon, said at least one scale being communicably coupled to the suitable computing device;
establishing a product identifier for all products located in the facility of the retailer, said product identifier configured to classify the products;
identifying at least one product for purchase, wherein the at least one user identifies a product for purchase;
transporting the product to the at least one scale;
creating a shopping list database, wherein the shopping list database includes the product identifiers for the at least one product selected by the user; and
paying the at least one retailer for the products listed on the shopping list database.

2. The method operable to facilitate purchase of at least one bulk item from a retailer as recited in claim 1, and further including the step of weighing the at least one product, wherein the at least one product is weighed utilizing the scale.

3. The method operable to facilitate purchase of at least one bulk item from a retailer as recited in claim 2, and further including the step of transmitting the weight of the at least one product to the software application, wherein the weight of the at least one product is stored with the product identifier.

4. The method operable to facilitate purchase of at least one bulk item from a retailer as recited in claim 3, and further including the step of procuring at least one container, said at least one container configured to have items placed therein, said at least one container having a container identifier, said container identifier having information pertinent to the at least one container.

5. The method operable to facilitate purchase of at least one bulk item from a retailer as recited in claim 4, wherein the container identifier further includes a weight of the container.

6. The method operable to facilitate purchase of at least one bulk item from a retailer as recited in claim 5, and further including the step of weighing the at least one container, wherein the at least one container does not have an established weight.

7. The method operable to facilitate purchase of at least one bulk item from a retailer as recited in claim 6, and further including the step of linking a container identifier with the at least one container.

8. The method operable to facilitate purchase of at least one bulk item from a retailer as recited in claim 7, and further including the step of matching a weighed container with a container identifier.

9. The method operable to facilitate purchase of at least one bulk item from a retailer as recited in claim 8, and further including the step of capturing an image of the at least one container, wherein a photographic image is captured and stored.

10. The method operable to facilitate purchase of at least one bulk item from a retailer as recited in claim 9, and further including the step of weighing the at least one container ensuing all products desired being placed therein.

11. The method operable to facilitate purchase of at least one bulk item from a retailer as recited in claim 10, and further including the step of calculating a total weight of the at least one container, wherein the total weight is derived from all product identifiers and a weight associated with each.

12. The method operable to facilitate purchase of at least one bulk item from a retailer as recited in claim 11, and further including the step of transferring the shopping list database, wherein the shopping list database is transferred from the at least one user to retailer.

13. A method configured to facilitate the purchase of a plurality of bulk items wherein the bulk items are placed in containers and subsequently purchased wherein the method comprises the steps of:
providing a software application, wherein the software application is published to a computer server wherein the computer server is communicably available to additional computing devices;
downloading the software application, wherein the software application is downloaded by a user to a smart phone;
establishing an account, wherein the account is created for the user via inputting data about the user into the software application;
receiving at least one container, said at least one container being received by the user, said at least one container configured for use in gathering portions of bulk items;
capturing an image of the at least one container, said image of the container retained by the software application;
inputting a container identifier for the at least one container, wherein the container identifier is retained by the software application;
weighing the at least one container, wherein the at least one container is weighed without any items disposed therein;
storing a weight of the at least one container, wherein the weight of the at least one container is stored with the container identifier;
providing a plurality of scales, wherein the plurality of scales are disposed in a facility of a bulk retailer, said plurality of scales communicably coupled to the smart phone of the user;
inputting a plurality of product identifiers, wherein the plurality of product identifiers are operable to categorize all products available for sale in the facility of the bulk retailer;
selecting at least one product, wherein the user will select at least one product at the facility of the bulk retailer;
inputting the product identifier for the selected at least one product, wherein the product identifier for the selected at least one product is entered into the software application;
weighing the selected at least one product, wherein the user will weigh the selected at least one product;
placing the at least one product into the container;
populating the weight into the software application;
creating a list of products placed into the container; and
transferring the list of products placed into the container to the bulk retailer in order to facilitate payment for the products on the list of products.

14. The method configured to facilitate the purchase of a plurality of bulk items as recited in claim 13, and further including the step of populating the weight of the selected at least one product, wherein the weight of the at least one product is associated with the product identifier of the selected at least one product.

15. The method configured to facilitate the purchase of a plurality of bulk items as recited in claim 14, and further including the step of utilizing a container with an established weight, wherein the container with the established weight is provided by the bulk retailer.

16. The method configured to facilitate the purchase of a plurality of bulk items as recited in claim 15, and further including the step of creating a shopping list database, wherein the shopping list database is an inventory of all products selected during a shopping excursion and placed in the container.

17. The method configured to facilitate the purchase of a plurality of bulk items as recited in claim 16, and further including the step of selecting a product identifier from a list, wherein the user selects a product identifier for a product desired to be purchased.

18. The method configured to facilitate the purchase of a plurality of bulk items as recited in claim 17, and further including the step of weighing the container wherein the container has disposed therein all of the products desired for purchase.

19. The method configured to facilitate the purchase of a plurality of bulk items as recited in claim 18, wherein the product identifiers and container identifiers are QR codes or barcodes.
